(19) United States
(12) Patent Application Publication
(10) Pub. No.: US 2009/0215913 A1
(43) Pub. Date: Aug. 27, 2009

(54) Highly porous polymeric materials comprising biologically active molecules via covalent grafting

(76) Inventors: Jens Christoph Thies, Maastricht (NL); Sebastien Pierre, Maastricht (NL); Neil Ronald Cameron, Durham (GB)

Correspondence Address: NIXON & VANDERHYE, PC, 901 NORTH GLEBE ROAD, 11TH FLOOR, ARLINGTON, VA, 22203, US

(21) Appl. No.: 11/918,777

(22) PCT Filed: Apr. 21, 2006
(86) PCT No.: PCT/EP2006/003677

§ 371 Date: Feb. 17, 2009

(30) Foreign Application Priority Data
Apr. 22, 2005 (EP) 05075957.0

(51) Int. Cl. C08J 9/36; C08J 9/00

(52) U.S. Cl. 521/53; 521/149

(57) ABSTRACT

The present invention relates to highly porous polymeric materials comprising covalently grafted biologically active species. The invention also relates to a process for the preparation of highly porous materials comprising functional monomers capable of grafting to a biologically active molecular species comprising the steps of: (a) preparing an emulsion composition comprising a droplet phase and a continuous phase and containing monomers, (b) curing the emulsion and (c) optionally removing the water/droplet phase. The invention further relates to a process for grafting biologically active species to such a highly porous polymeric material comprising the steps of: (i) exposing the highly porous material to a solution of the biologically active species in a suitable solvent medium, (ii) optionally adding an activating agent, (iii) optionally heating, and (iv) rinsing the porous material with solvent medium to remove non-grafted species. The highly porous polymeric materials comprising covalently grafted biologically active species can be used e.g. as a heterogeneous catalyst, in biosensors, for chromatography, in biomedical devices and in implants.

The invention relates to highly porous materials comprising biologically active molecular species that are attached to the porous material. The invention also relates to methods of producing highly porous materials capable of covalently grafting biologically active molecules and methods for grafting said biologically active molecules to the porous material. Furthermore the invention relates to the application of such highly porous materials comprising biologically active molecules via covalent grafting in heterogeneous catalysis, biosensors, chromatography, biomedical devices and implants. Moreover the invention relates to any biologically and biochemically active device based on highly porous materials comprising biologically active molecules via covalent grafting according to-the invention.

Biologically active molecular species such as enzymes have previously been immobilized onto hydrophobic porous polymeric materials by hydrophobic-hydrophobic interactions [E. Ruckenstein and X. Wang, Biotech. and Bioeng., Vol 42 pg 821 (1993)]. This physisorption is non covalent and while the biologically active molecular species (enzyme) retains some of its activity, the nature of the physisorption is such that the biologically active molecular species can be removed (leached) from the polymeric support and therefore the activity of the system drops with subsequent reuse. This can also be seen for commercial systems where enzymes have been immobilized onto polymer beads via non-covalent physisorption processes, such as Novozyme 435.

Biologically active molecular species have also been immobilized covalently onto polymers-for example onto derivatives of agarose [R. G. Frost et al, Biochimica et Biophysica Acta, 670, pg 163, (1981)]. This can lead to retention of the biological or biochemical activity. However, these systems are non-porous or highly viscous polymer gels and diffusion of compounds, which are intended reactants in bio-catalysis procedures or which interact with the immobilized biologically active molecular species, is severely hampered.

There remains a need therefore for an effective way to immobilize biologically active molecular species such as, for example, proteins and enzymes to solid supports in such a way that the biologically active molecular species does not leach away from the surface of the solid support and thus not result in stability problems leading to a loss in biological or biochemical activity. Furthermore, it is also desirable for the solid support materials to be as porous as possible while maintaining mechanical integrity in order to have as large a surface area as possible available for immobilization and thus for subsequent biological and biochemical action. Moreover, high porosity would be beneficial for applications where the immobilized enzyme is exposed to a liquid flow of compounds with which the biologically active molecular species are intended to interact, react or cause the reaction of.

Surprisingly, it has been found that excellent activity and stability of immobilized biologically active molecular species can be achieved by immobilizing the said species to a highly porous polymeric support via covalent grafting. In this way the biologically active molecular species are bound to the highly porous polymeric support via covalent molecular bonds and are thus said to be grafted. Once grafted in this way the biologically active molecular species can no longer be removed from the support without some sort of degradation reaction which thus retains its biological activity.

The invention also relates to a process for the preparation of highly porous materials comprising functional monomers capable of grafting the said biologically active molecular species comprising the steps of:

a. Preparing an emulsion composition comprising a droplet phase and a continuous phase and containing monomers

b. Curing the emulsion

c. Optionally removing the water/droplet phase.

Apart from the monomers, the emulsion composition can also contain cross-linking monomers, functional monomers, polymerization initiators, surfactants and water.

The curing of the emulsion can be done e.g. thermally or photo-chemically.

The removal of the water/droplet phase advantageously can be carried out by e.g. evaporation, freeze-drying, filtration under suction.

A further embodiment of the present invention relates to a process for preparing highly porous polymeric materials capable of covalently grafting biologically active species comprising the steps of:

a. Preparing an emulsion comprising a droplet phase and a continuous phase from a composition comprising:

A) 5-95 wt % of a functional monomer

B) 5-80 wt % of a cross-linking monomer

C) 0-10 wt % of a polymerization initiator

D) 0-20 wt % of a surfactant

E) 0-90 wt % of a monomer other than a functional or cross-linking monomer wherein the weight percentage are relative to the total weight of A, B, C, D and E, and F, between 74-93 vol % of a liquid or liquid composition that constitutes the droplet phase, whereby the vol % is relative to the total volume of the continuous phase comprising A, B, C, D and E and the droplet phase.

b. Curing the emulsion, and

c. Optionally removing the water/droplet phase.

Within the context of the invention the term highly porous polymeric material refers to any polymeric material with porosity greater than 74% in terms of total void volume. In particular, such materials can be prepared by the polymerization of High Internal Phase Emulsions (HIPEs) and once polymerised are known in the art as polyHIPEs (D. Barby & Z. Haq, Eur. Pat. Appl. 60138, 1982). These highly porous materials resulting from the above described process are monolithic materials, i.e. the process result in one piece of material. By contrast, known polymeric materials polymeric materials with biologically active species grafted thereon, are usually in the form of beads or gains.

The first process of this invention comprises the step of preparing a suitable emulsion composition comprising various monomers and subsequently curing or cross-linking the monomer phase.

Poly-HIPEs are made from the polymerization of High Internal Phase Emulsions (HIPEs). A HIPE is an emulsion where the droplet phase occupies more than 74% of the total volume (K. J. Lissant (Ed.), Emulsions and Emulsion Technology Part 1, Marcel Dekker, New York, 1974, chapter 1). In the case of HIPEs, the continuous phase contains the monomers that can be polymerized and give their typical cell structure to poly-HIPEs. Shrinkage of the polymer cannot happen on a macroscopic level due the emulsion droplet structure. As a result, shrinkage happens in the continuous phase between the droplets and interconnecting windows appear in the cell walls, making poly-HIPEs completely permeable to liquid and gaseous media and thus useable for flow-through applications in their monolithic form.

There are two types of poly-HIPEs, the most common being those made from inverse emulsions (often called “water in oil” emulsion) and the others being made from normal emulsions (“oil in water” emulsion).

The continuous phase in a poly-HIPE made from an inverse emulsion is the phase containing monomers, preferably hydrophobic monomers, and most preferably monomers not miscible with the droplet phase. Styrene and acrylate-based polyHIPEs described in the examples of this invention belong to this type of polyHIPEs. At least one monomer with more than one polymerizable moiety, referred as cross-linker, has to be used. Monomers miscible with the droplet phase are useable but may not be fully polymerized due to their partial dissolution in the droplet phase. The continuous phase contains at least one surfactant to enhance the emulsion stability, preferably a non-ionic surfactant. The continuous phase can contain at least one non-polymerizable species, preferably a chemical not miscible with the droplet phase, and most preferably a hydrophobic solvent, often referred to as porogen as it is used to increase the surface area of the poly-HIPE by adding roughness and creating more voids in the open-cell structure (P. Hainey, I. M. Huxham, B. Rowatt, D. C. Sherrington, and L. Tetley, Macromolecules, 1991, 24, 117; A. Barbetta and N. R. Cameron, Macromolecules, 2004, 37, 3202).

The droplet phase in a poly-HIPE made from an inverse emulsion is a hydrophilic liquid medium, preferably a hydrophilic solvent, and most preferably water. It can contain salts or chemicals whose purpose is to stabilize the emulsion by decreasing the miscibility with the continuous phase, a photo-initiator, or a mixture of both but these can also be included in the continuous phase as well as in both phases. It can finally contain at least one monomer susceptible to partially polymerize at the interface with the continuous phase, preferably a monomer also present in the continuous phase.

The continuous phase in a poly-HIPE made from a normal emulsion is the phase containing monomers, preferably hydrophilic monomers, and most preferably monomers not miscible with the droplet phase. An example is macromonomers terminated by aryl ether sulfone moieties. At least one monomer with more than one polymerizable moiety, referred as cross-linker, has to be used. Monomers miscible with the droplet phase are useable but will not be fully polymerized due to their partial dissolution in the droplet phase. The continuous phase contains at least one surfactant to enhance the emulsion stability, preferably ionic. The continuous phase can contain at least one non-polymerizable species, preferably a chemical not miscible with the droplet phase, and most preferably a hydrophilic solvent such as water, often referred to as porogen as it is used to increase the surface area of the poly-HIPE by adding roughness and creating more voids in the open-cell structure.

The droplet phase in a poly-HIPE made from a normal emulsion is a hydrophobic liquid medium, preferably a hydrophobic solvent. Examples are petroleum ether, hexane, and supercritical carbon dioxide. It can contain chemicals whose purpose is to stabilize the emulsion by decreasing the miscibility with the continuous phase. It can contain at least one initiator, such as a free radical initiator or a photo-initiator, or a mixture of both but these can also be included in the continuous phase as well as in both phases. It can finally contain at least one monomer susceptible to partially polymerize at the interface with the continuous phase, preferably a monomer also present in the continuous phase.

HIPEs are defined by their high volume ratio with respect to the droplet phase (more than 74%) which yields polymers at least 74% porous after removal of the droplet phase unless the monolith collapses upon drying. There are examples of poly-HIPEs with porosity of 99% (J. Esquena, G. S. R. R. Sankar, and C. Solans, Langmuir, 2003, 19, 2983.). Such materials are very permeable to liquid media and gas under in monolithic form due to the windows interconnecting the cells.

In principle any molecule which upon reaction forms polymeric materials can be used as a monomers within the context of the invention. It is only important to select monomers, which are soluble in the continuous phase of the high internal phase emulsion. For water-in-oil type of HIPEs, where the organic phase is the continuous phase, such monomers should preferably be well soluble in the organic phase and insoluble in the water phase. The reverse is true for oil in water HIPEs.

The cross-linking monomer should be a monomer whose functionality is such that it forms a crosslink between two or more polymer chains during polymerization and thus leads to the formation of a cross-linked network. The selection of these cross-linking monomers should be based on the solubility in the continuous phase as is the case for monomers as described above.

Within the context of the invention the functional monomer comprises at least one chemical moiety, which can participate in the polymerization, and at least one other chemical moiety, which in a second step can react with a biologically active molecular species and thus effect the grafting of the biological active molecular species to the polymeric material. In an embodiment of the invention the chemical moiety capable of grafting can be reacted in an intermediate step with an other molecule, which in turn can graft a biologically active molecular species. In another embodiment, a monomer is used that is both a cross-linking monomer and a functional monomer. Thus, such monomer comprises at least two preferably 3 polymerizable groups and a chemical moiety, which can react with a biologically active species. Such a monomer may be used in an amount of between 5 and 95 wt %, relative to the total weight of the components A, B, C, D and E, referred to above.

This can be expressed by the general structural formula 1a) P-G, where P refers to the chemical moiety involved in polymerization and G is the chemical moiety which is subsequently used to graft the biologically active molecular species either directly or indirectly, or alternatively as formula lc) P-X-G, wherein P and G are as described above, and X any spacer group, which spacer group may be hydrophilic or hydrophobic. Examples are alkyl-, perfluoralkyl, ethyleneglycol or other oligo-ethers.

In a preferred embodiment the functional monomers contain an active ester group and most preferably an activated ester group based on n-hydroxy succinimide, of formula 2.

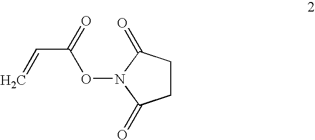

Other examples of functionalities which can be used to graft biologically active molecular species include but are not limited by maleimides, thiols, isothiocyantes, iodoacetamide, 2-pyridyl derivatives, azides, oximes, epoxides, isocyanates and aldehydes.

The selection of these functional monomers should also, in part, be based on their solubility in the monomer phase as is the case for monomers and cross-linking monomers, as described above.

It is possible to introduce a spacer group between the P and G groups of an n-hydroxysuccimide based monomers as is shown schematically in formula 3.

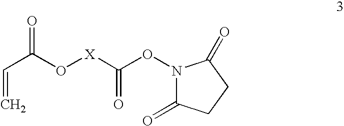

In this way the hydrophobicity can be tuned by choosing a spacer group (x) consisting such as for example but not limited to, an alkyl chain of three methylene groups or more. Furthermore, hydrophilicity can be tuned by choosing a spacer group (X) which is intrinsically hydrophilic such as for example but not limited to ethylene oxide units of various length n (CH₂CH₂O)ₙ.

In a further embodiment of the present invention the monomers, crosslinking monomers and functional monomers contain vinylic unsaturation and are preferably styrenic, more preferably methacrylic and most preferably acrylic.

Initiators being used according to the present invention may be water soluble or organic soluble and may be added entirely to either phase, portioned between phases and may be added before, during or after emulsion formation.

If one or more initiators or initiator parts are used in combination these may be added together or separately as desired. Initiators may be photoinitiators and/or thermal initiators and/or redox initiators.

The initiator should be present in an effective amount to polymerize the monomers. Typically, the initiator can be present in an amount of from about 0.005 to about 20 weight percent, preferably from about 0.1 to about 15 weight percent and most preferably from about 0.1 to about 10 weight percent, based on the total continuous phase.

Useful initiators in the process according to the present invention may be e.g. photoinitiators or thermal initiators.

Photoinitiators include but are not limited to the following examples: Acetophenone, Anisoin, Anthraquinone, Anthraquinone-2-sulfonic acid, sodium salt, tricarbonylchromium, Benzil, Benzoin, Benzoin ethyl ether, Benzoin isobutyl ether, Benzoin methyl ether, Benzophenone, Benzophenone/1-Hydroxycyclohexyl phenyl ketone, 50/50 blend, 3,3′,4,4′-Benzophenonetetracarboxylicdianhydride, 14-Benzoylbiphenyl, 2-Benzyl-2-(dimethylamino)-4′-morpholinobutyrophenone, 4,4′-Bis(diethylamino)benzophenone, 4,4′-Bis(dimethylamino)benzophenone, 3 Camphorquinone, 2-Chlorothioxanthen-9-one, (Cumene)cyclopentadienyliron(II), hexafluorophosphate, Dibenzosuberenone, -Diethoxyacetophenone, 4,4′-Dihydroxybenzophenone, 2,2-Dimethoxy-2-phenylacetophenone, 4-(Dimethylamino)benzophenone, 4,4′-Dimethylbenzil, 2,5-Dimethylbenzophenone, 3,4-Dimethylbenzophenone, Diphenyl(2,4,6-trimethylbenzoyl)phosphine oxide/2-Hydroxy-2-methylpropiophenone, 50/50 blend, 4′-Ethoxyacetophenone, 2-Ethylanthraquinone, Ferrocene, 3′-Hydroxyacetophenone, 4′-Hydroxyacetophenone, 3-Hydroxybenzohpenone, 4-Hydroxybenzophenone, 1-Hydroxycyclohexyl phenyl ketone, 2-Hydroxy-2-methylpropiophenone, 2-Methylbenzophenone, 3-Methylbenzophenone, Methybenzoylformate, 2-Methyl4′-(methylthio)-2-morpholinopropiophenone, Phenanthrenequinone, 4′-Phenoxyacetophenone, Thioxanthen-9-one, Triarylsulfonium hexafluoroantimonate salts, Triarylsulfonium hexafluorophosphate salts.

Thermal initiators include but are not limited to the following examples:

tert-Amyl peroxybenzoate, 4,4-Azobis(4-cyanovaleric acid), 1,1′-Azobis(cyclohexanecarbonitrile), 2,2′-Azobisisobutyronitrile (AIBN), Benzoyl peroxide, 2,2-Bis( tert-butylperoxy)butane, 1,1-Bis( tert-butylperoxy)cyclohexane, 2,5-Bis( tert-butylperoxy)-2,5-dimethylhexane, 2,5-Bis( tert-Butylperoxy)-2,5-dimethyl-3-hexyne, Bis(1-( tert-butylperoxy)-1-methylethyl)benzene, 1,1-Bis( tert-butylperoxy)-3,3,5-trimethylcyclohexane, tert-Butyl hydroperoxide, tert-Butyl peracetate, tert-Butyl peroxide, tert-Butyl peroxybenzoate, tert-Butylperoxy isopropyl carbonate, Cumene hydroperoxide, Cyclohexanone peroxide, Dicumyl peroxide, Lauroyl peroxide, 2,4-Pentanedione peroxide, Peracetic acid.

Initiators can be employed alone or in combination with other initiators, reducing agents, and/or catalysts. Reducing agents and catalysts useful in redox polymerization systems are well known, and the selection of a particular reducing agent or catalyst for a given initiator is within the level of skill in the art.

Examples of reducing agents useful in redox systems include ferrous iron, bisulfites, thiosulfates, and various reducing sugars and amines. Conveniently, ascorbic acid, sodium hydrosulfite and/or N,N,N′,N′-tetramethylenediamine is employed as the reducing agent.

Reducing agents or catalysts, where used, are typically introduced when polymerization initiation is desired, i.e., generally after the emulsion has been formed. The initiator can be added to the aqueous phase or to the oil phase, depending on whether the initiator is water-soluble or oil-soluble. Combinations of water-soluble and oil-soluble initiators can also be used.

Optionally, the internal aqueous phase can include a water-soluble electrolyte for aiding the surfactant in forming a stable emulsion. Water-soluble electrolytes include inorganic salts (monovalent, divalent, trivalent or mixtures thereof), for example, alkali metal salts, alkaline earth metal salts and heavy metal salts such as halides, sulfates, carbonates, phosphates and mixtures thereof. Such electrolytes include, for example, sodium chloride, sodium sulfate, potassium chloride, potassium sulfate, lithium chloride, magnesium chloride, calcium chloride, magnesium sulfate, aluminum chloride and mixtures thereof. Mono- or divalent salts with monovalent anions, such as halides, are preferred.

A further embodiment according to the present invention is the covalent grafting of the biologically active molecular species to the highly porous polymeric support prepared according to the first process, comprising the steps of:

a. Exposing the highly porous material to a solution of the biologically active molecular species in a suitable solvent medium.

b. Optionally adding an activating agent

c. Optionally heating

d. Rinsing the porous material with a solvent medium to remove non-grafted species.

Alternatively the grafting of the biological material may occur together with the polymerization of the monomers. A precondition for such a procedure is that conditions are applied wherein the polymerization process does not substantially effect the activity of the biological material and that the inclusion of biological material does not substantially effect the stability of the emulsion or the polymerization process.

An activating agent that is optionally used in the above step b) is a compound that enhances the reaction between the porous material and the biologically active species such as e.g. a catalyst or an initiator.

Within the context of the invention, biologically active molecular species refer to any biological, bio-derived or bio-mimetic molecular species which once grafted to the highly porous polymeric support, can interact with a biological system, react with a biological system or cause the reaction of a biological or chemical species via a biochemical mechanism as known to the skilled artisan.

Such biologically active molecular species may include, but are not limited to: nucleic acids, nucleotides, oligo-saccharides, peptides, peptide nucleic acids and glyco-proteins, proteoglycans, antibodies, lipids or mimics of any of the above.

In a preferred embodiment of the invention the biologically active molecular species are proteins or enzymes, where enzymes as known in art are referred to as bio-catalytic proteins.

In a further preferred embodiment of the invention the biologically active molecular species may be a mixture of different species such as mixtures of proteins, mixtures of enzymes and proteins and most preferably mixtures of enzymes. In immobilizing two or more enzymes as according to the invention it is possible to carry out multi-step bio-catalyzed reactions in what is known in the art as enzymatic cascade synthesis.

The solvent medium used in the second process in steps i) and iii) can be any solvent system which is capable of forming stable solutions of the biologically active molecular species. The solvent medium may be water or an organic solvent, more preferably an aqueous buffer solution or a mixture of organic solvent and aqueous buffer. The solvent medium used in steps i) and iii) may be the same or a different solvent medium may be used in step iii).

The invention also relates to the use of highly porous polymeric materials comprising biologically active molecules via covalent grafting for application in heterogeneous catalysis. Moreover the invention relates to such applications in heterogeneous catalysis where the bio-catalytic activity remains at 90% or greater of the original activity after 10, more preferably 50 and most preferably 100 reaction and rinsing cycles.

Furthermore the invention relates to the use of highly porous polymeric materials comprising biologically active molecules via covalent grafting in bio-sensors, chromatography, biomedical devices and implants as well as any biologically or biochemically active device according to the invention.

The invention also relates to the use of the highly porous polymeric materials comprising biologically active molecules via covalent grafting for analytical purposes, hence in order to convert the presence or absence of some chemical entity into a signal which is detectable and which correlates qualitatively or quantitatively with the presence or absence of the chemical entity.

### LEGEND TO FIGURES

FIG. 1/10 Scanning electron micrograph of Comparative example 1.

FIG. 2/10 Scanning electron micrographs of Comparative examples

A. Comparative example 2

B. Comparative example 3

C. Comparative example 4

D. Comparative example 5

FIG. 3/10 Scanning electron micrographs of poly-HIPEs containing succinimide esters.

A. Example 4

B. Example 6

C. Example 7

D. Example 8

FIG. 4/10 Calibration curve for the protein measurement test.

FIG. 5/10 Pictures of fluorescent poly-HIPEs (poly-HIPEs from comparative example 2, and examples 1, 2 and 4 from left to right). Exposure time: 500 ms. Magnification: ×1.6.

FIG. 6/10 Superposition of Raman spectra of cubes from comparative example 2 (a, black) and example 2 (b. red), both exposed to rAce-GFP, and the Raman spectrum of rAce-GFP in solution (c, blue). Intensities are not normalized.

FIG. 7/10 Activity curves for the hydrolysis of para-nitrophenyl acetate by Novozym N525L (CAL-B in aqueous solution).

FIG. 8/10 Flow-cell set-up for quantification of CAL-B activity on porous supports.

FIG. 9/10 Hydrolysis of para-nitrophenyl acetate by CAL-B (N525L) on different supports. Activities normalised by gram of support.

FIG. 10/10 Hydrolysis of para-nitrophenyl acetate by CAL-B (N525L) on different supports. Activities normalised by milligram of CAL-B initially present in the supports.

### EXAMPLES

All chemicals were used as received unless specified otherwise.

The UV-radiation curing system used was a Fusion DRSE-120QNL irradiator, equipped with an 1600M D-bulb. Total UV intensity (A+B+C) was set at 1.0 J/cm² (belt speed: 20 feet/min).

The scanning electron microscope was a Philips XL30CP. Samples were all gold-coated to enhance conductivity, mounted on aluminium stubs with carbon paste and the electron beam was set up at 5 to 20 kV depending on the magnification.

The fluorescence optical microscope was a Leika MZFLIII, coupled with a Leika CC-12 camera. A blue filter was used (480±50 nm). PolyHIPE samples were deposed on glass slides with black background.

The UV-visible spectrophotometer was a Hitachi U-2000 including a peristaltic pump to use with flow cells. Absorbance at 400 nm was monitored and values were taken every 10 seconds.

### Comparative Example 1

Comparative example 1 is the product of a batch process to make a highly porous material thermally polymerized from a High Internal Phase Emulsion.

Styrene (4.5 ml, Aldrich), divinylbenzene (0.5 ml, Aldrich), and SPAN8O, which is sorbitan mono-(Z)-9-octadecenoate (1.0 ml, Aldrich) were placed in a 50 ml wide-necked plastic bottle, and were stirred with a steel stirring rod fitted with a rectangle-shaped PTFE paddle, connected to an overhead stirrer motor, at 300 rpm. A nitrogen flux was maintained over the bottle. De-ionized and degassed water (45 ml) containing potassium persulfate (0.22 g, Aldrich) and calcium chloride (0.50 g, anhydrous, Aldrich) was added drop wise (approximately 1 ml/min), with constant stirring, to form the HIPE. As the aqueous phase was added, the bottle was lowered to maintain stirring just below the surface of the developing HIPE, ensuring that no water pockets formed. Once all the aqueous phase had been added, stirring was continued for a further 10 min, to produce as uniform an emulsion as possible. Then the bottle was put in an oven flushed with nitrogen and heated at 60° C. during 48 h. The bottle was cut and the tubular piece of polymer was put inside a Soxhlet apparatus and washed for 24 h with water (200 ml) and then for 24 h with acetone (200 ml). Then the monolith was dried in an oven under light vacuum at 50° C. during 24 h.

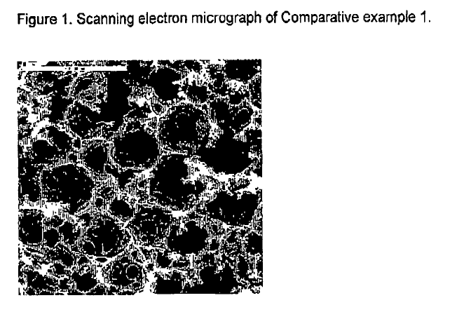

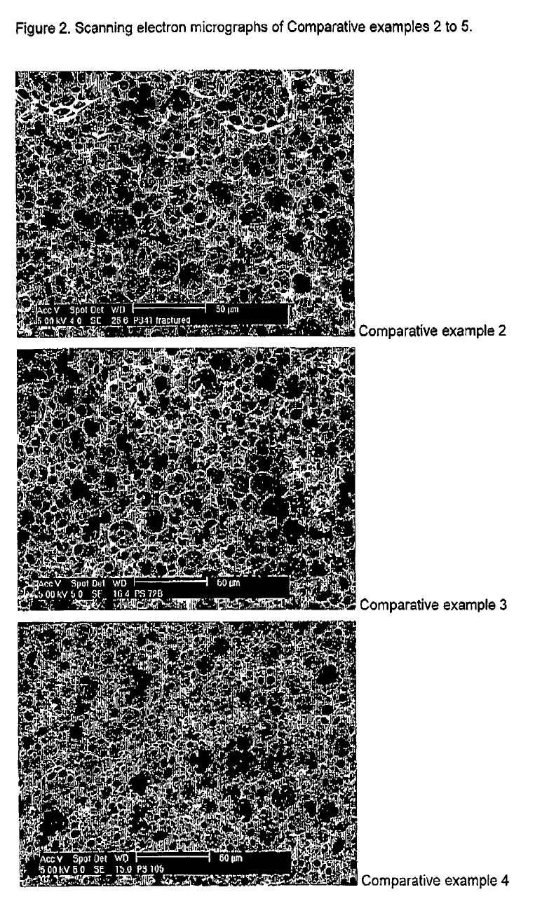

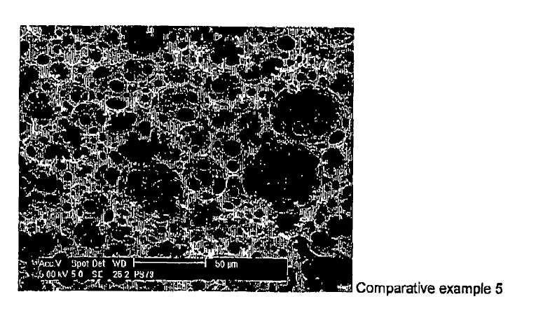

The polymer was hard and brittle, which was typical of pure styrenic poly-HIPEs. The density of comparative example 1 measured by water displacement was approximately 0.09 g/cm³ as expected with a ratio continuous phase/droplet phase of 1:9. The typical surface area measured by nitrogen absorption and applying the Brunauer-Emmet-Teller model area was approximately 4 m²/g. FIG. 1 is a scanning electron micrograph showing the open-cell structure characterizing the poly-HIPEs.

### Comparative Example 2-5

Comparative examples 2 to 5 are produced from a batch process to make highly porous materials photo-polymerized from High Internal Phase Emulsions comprising various ratios of the main monomers. Weight percentages refer to the total weight of the continuous phase (5.00 g in Comparative examples 2-5).

For comparative example 2, 2-ethylhexyl acrylate (from Aldrich, see Table 1), isobornyl acrylate (from Aldrich, see Table 1), trimethylolpropane triacrylate (from Aldrich, see Table 1), SPAN80 which is sorbitan mono-(Z)-9-octadecenoate (from Aldrich, see Table 1) and Darocur 4265, a 50/50 blend of DAROCUR TPO (diphenyl(2,4,6-trimethylbenzoyl)-phosphine oxide) and DAROCUR 1173 (2-hydroxy-2-methyl-1-phenyl-1-propanone, (from Ciba Geigy, see Table 1) were placed in a 50 ml wide-necked plastic bottle, and were stirred with a steel stirring rod fitted with a rectangle-shaped PTFE paddle, connected to an overhead stirrer motor, at 300 rpm. A nitrogen flux was maintained over the bottle. De-ionized and degassed water (see Table 1) was added drop wise (approximately 1 ml/min), with constant stirring, to form the HIPE. As the aqueous phase was added, the bottle was lowered to maintain stirring just below the surface of the developing HIPE, ensuring that no water pockets formed. Once all the aqueous phase had been added, stirring was continued for a further 10 min, to produce as uniform an emulsion as possible. If not polymerized within 2 h, the HIPE had to be stirred again for 10 min prior to use, to ensure a homogenous droplet size.

A square-shaped PTFE frame was used to create a mould (mould size: 5 cm side, 5 mm thickness) on a glass plate. The HIPE was poured inside and a second glass plate was used to close the mould. The mould was passed alternatively on each side 3 times (total UV-dose: 6×1.0 J/cm²) under a Fusion DRSE-120QNL irradiator equipped with a 1600M D bulb at 100% power, in focus, with a conveyer speed of 20 feet/min. The photo-polymerized HIPE was removed from the mould using a razor blade. The cured wet sample was immerged in 100 ml of a 1:1 (vol/vol) acetone/water mixture in a 600 ml beaker. Slow magnetic stirring was applied during 1 h at 60° C. Then the solution was replaced by another fresh 100 ml and stirred again at 60° C. for 1 h. This process was repeated 6 times. For the last washing, a 1:3 acetone/water mixture (vol/vol) was used. Then the wet poly-HIPE was frozen in a −80° C. freezer until it was completely frozen and put into a freeze-drier for 24 h to yield a dry poly-HIPE with less than 5% shrinkage in size. Samples dried without freeze-drying exhibited a 40 to 50% shrinkage. In all cases, shrinkage was completely reversible when samples were made wet again using organic buffer mixture. Water uptake by dry poly-HIPEs was very slow unless some organic solvent was mixed with aqueous buffers or water.

For comparative examples 2 to 5, quantities of 2-ethylhexyl acrylate and isobornyl acrylate were changed according to Table 1, yielding poly-HIPEs ranging from soft and elastic (comparative example 2) to hard and brittle (comparative example 5) as an effect of the increase of isobornyl acrylate quantity.

The typical density of dry poly-HIPEs prepared in these examples and measures by water displacement was approximately 0.10 g/cm³ as expected with a ratio continuous phase/droplet phase of 1:9. The typical surface area measured as above area was approximately 1.9 m²/g

TABLE 1
Formulation of comparative examples 2 to 5

| | | | | | | Water:oil |
|---|---|---|---|---|---|---|
| | % weight/oil phase total weight | | | | | phase ratio |
| PolyHIPE | EHA | IBOA | TMPTA | SPAN80 | Darocur 4265 | (water weight) |
| Comp ex 2 | 60% | 10% | 10% | 13% | 7% | 9:1 |
| | (3.00 g) | (0.50 g) | (0.50 g) | (0.65 g) | (0.35 g) | (45 g) |
| Comp ex 3 | 40% | 30% | 10% | 13% | 7% | 9:1 |
| | (2.00 g) | (1.50 g) | (0.50 g) | (0.65 g) | (0.35 g) | (45 g) |
| Comp ex 4 | 30% | 40% | 10% | 13% | 7% | 9:1 |
| | (1.50 g) | (2.00 g) | (0.50 g) | (0.65 g) | (0.35 g) | (45 g) |
| Comp ex 5 | 20% | 50% | 10% | 13% | 7% | 9:1 |
| | (1.00 g) | (2.50 g) | (0.50 g) | (0.65 g) | (0.35 g) | (45 g) |

### Examples 1-9

Examples 1 to 9 are highly porous polymers including the functional monomer N-acryloxysuccinimide (NASI) and thus are able to covalently graft biologically active species.

For example 4, 2-ethylhexyl acrylate (from Aldrich, see Table 2), isobornyl acrylate (from Aldrich, see Table 2), trimethylolpropane triacrylate (0.50 g, from Aldrich), surfactant SPAN80 (0.65 g, from Aldrich) and Darocur 4265 (0.35 g, a photoinitiator from Ciba Geigy) were placed in a 50 ml wide-necked plastic bottle, and were stirred with a steel stirring rod fitted with a rectangle-shaped PTFE paddle, connected to an overhead stirrer motor, at 300 rpm. N-acryloxysuccinimide (from Acros, see Table 2) was added in three portions, and time was given to achieve full dissolution before the next portion was added. A nitrogen flux was maintained over the bottle De-ionized and degassed water (45 g) containing N-acryloxysuccinimide (from Acros, see Table 2) was added drop wise (approximately 1 ml/min), with constant stirring, to form the HIPE. As the aqueous phase was added, the bottle was lowered to maintain stirring just below the surface of the developing HIPE, ensuring that no water pockets, i.e. areas where the reaction mixture is inhomogeneous, in the case where there is more than one droplet of the water phase formed. Once all the aqueous phase had been added, stirring was continued for a further 10 min, to produce as uniform an emulsion as possible. If not polymerized within 2 h, the HIPE had to be stirred again for 10 min prior to use, to ensure an optimum droplet size.

The curing of this formulation was done as shown for Comparative examples 2-5, as well as the washing and drying of the resulting highly porous functional polymers. The density and surface area was also similar to Comparative example 2-5.

Poly-HIPEs according to Examples 1-3 and 5-9 were made in the same way. The amount of starting materials for each of Examples 1-5 are given in Table 2. The amounts not given in Table 2, are the same as described for Example 4.

Examples 1 to 4 were made from emulsions containing 10% w/w of isobornyl acrylate in the continuous phase, whereby the weight percentage is relative to the total weight of the materials constituting the continuous phase (i.e. EHA, IBOA, NASI (excluding NASI in the droplet phase) SPAN 80 and DAROCUR). They contain various amounts of N-acryloxysuccinimide introduced in the continuous phase, in the droplet phase, or both.

Examples 5 to 8 were made from emulsions containing 30% w/w of isobornyl acrylate in the continuous phase. They contain various amounts of N-acryloxysuccinimide introduced in the continuous phase, in the droplet phase, or both.

Example 9 was made from an emulsion containing 40% w/w of isobornyl acrylate in the continuous phase. N-acryloxysuccinimide could only be introduced in the droplet phase; otherwise the emulsion could not be stabilized. Table 2 summarizes the differences in the emulsions made to prepare examples 1-9.

TABLE 2
Formulations of example 1 to 9 and loadings in succinimide
ester obtained from elemental analysis

| | | | | | | | NASI |
|---|---|---|---|---|---|---|---|
| | weights | | | | Reactive groups | | loading |
| | | | | NASI in | Max expected | Measured | Efficiency |
| PolyHIPE | EHA | IBOA | NASI | water | (mmol g⁻¹) | (mmol g⁻¹) | (%) |
| Example 1 | 2.75 g | 0.50 g | 0.25 g | — | 0.37 | 0.17 | 45 |
| Example 2 | 2.50 g | 0.50 g | 0.50 g | — | 0.74 | 0.44 | 59 |
| Example 3 | 3.00 g | 0.50 g | — | 0.375 g | 0.50 | 0.22 | 44 |
| Example 4 | 2.50 g | 0.50 g | 0.50 g | 0.375 g | 1.18 | 0.74 | 62 |
| Example 5 | 1.75 g | 1.50 g | 0.25 g | — | 0.37 | 0.15 | 40 |
| Example 6 | 1.50 g | 1.50 g | 0.50 g | — | 0.74 | 0.34 | 46 |
| Example 7 | 2.00 g | 1.50 g | — | 0.375 g | 0.50 | 0.21 | 43 |
| Example 8 | 1.50 g | 1.50 g | 0.50 g | 0.375 g | 1.18 | 0.55 | 46 |
| Example 9 | 1.50 g | 2.00 g | — | 0.375 g | 0.50 | 0.14 | 30 |

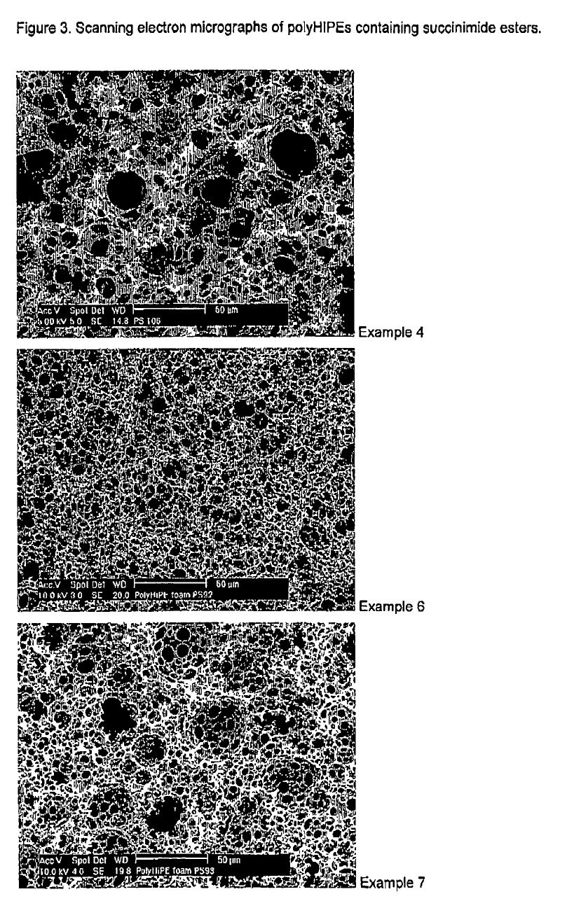

The scanning electron micrographs of examples in FIG. 3 show the effect of incorporation of N-acryloxysuccinimide. It partially disrupts the regularity of the open-cell structure and broadens the cell size distribution when it is introduced in the droplet phase (FIG. 3, example 7) and it leads to thinner cell walls when introduced only within the continuous phase (FIG. 3, example 6), due to its partial solubility in the droplet phase.

### Determination of Protein Concentration in Solution Using a Brad-Ford Assay

The Protein Assay Reagent from Bio-Rad, which is an adaptation of the Brad-Ford assay protein measurement test that was used to determine the concentration of a protein or an enzyme in pure aqueous buffer or an aqueous buffer containing up to 30% v/v ethanol.

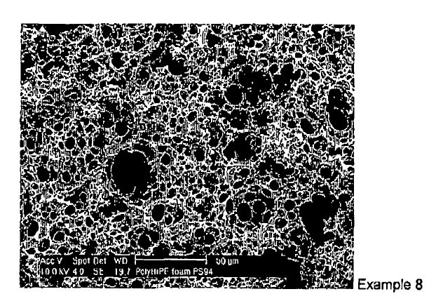

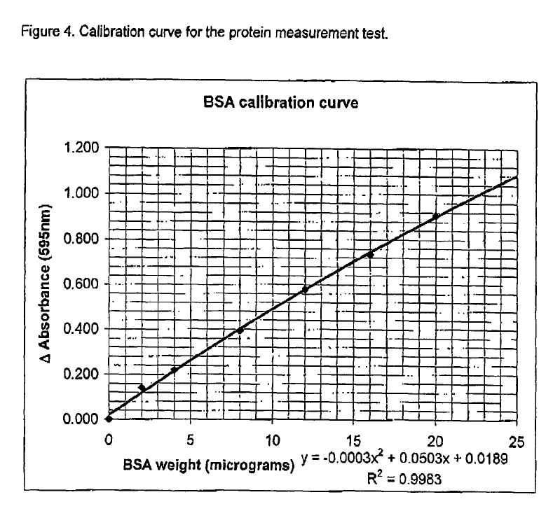

A series of dilutions in water was performed with the protein solution to prepare 0.8 ml samples with concentrations ranging from 0 to 25 μg/ml range. Then pure Protein Assay Reagent (0.2 ml) was added to each diluted sample. The reagent contains G-250 Coomassie Blue, a dye that reacts quickly with the basic and aromatic residues of the protein, forming a bright blue complex. After 10 minutes of stirring, samples were placed in a UV-visible spectrophotometer and absorbance at 595 nm was measured (the zero absorbance was set with the sample containing no protein). An external calibration curve was measured using samples with of Bovine Serum Albumin (BSA) ranging from 0 to 20 μg/ml. This curve (FIG. 4) was used to relate absorbance and protein quantity in the samples.

### Protocol for Buffer Exchange for a Green Fluorescent Protein

In this example the process used to prepare recombinant Green Fluorescent Protein (rAce-GFP) for the covalent immobilization on polyHIPEs containing succinimide esters (Examples 1-9) is described. It involved mostly dialysis of the protein to change the buffer and remove additives in which rAce-GFP was delivered.

Recombinant Ace-Green Fluorescent Protein from Evrogen was used. One vial of Ace-GFP (0.10 ml at 1 mg/ml) could be used for five polyHIPE samples (20 μg/sample). One vial was dialyzed against phosphate buffer (66 mM, pH 8.0) in Millipore Microcon YM-10 centrifugal units (molecular weight cut-off of the membrane: 10000). After 6 additions of phosphate buffer (0.5 ml) followed by centrifugations at 8000G for 20 minutes, the protein concentrate was completed to 2.0 ml using phosphate buffer (66 mM, pH 8.0) containing ethanol (30% v/v).

### Example 10

Example 10 describes a process for covalently grafting a Green Fluorescent Protein (rAce-GFP) onto poly-HIPEs with different loadings of N-acryloxysuccinimide (examples 1 to 9). Poly-HIPEs from comparative examples 24 have been used as negative controls. The immobilization process is the same for each poly-HIPE: a 5 mm poly-HIPE cube was cut, weighed and put into a 2.0 ml Eppendorf vial. The vial was filled with dialyzed rAce-GFP (0.40 ml) and put for stirring in a roller stirrer for 4 hours. Then the vial content was poured on a 5.5 cm diameter paper filter, vacuum was applied on the filter unit and phosphate buffer (66 mM, pH 7.0) containing ethanol (30% v/v) was added drop-wise on the poly-HIPE piece. The suction allowed a quick washing by driving the solvent through the polymer. 20 ml buffer was used for each piece and the washed GFP grafted poly-HIPEs cubes were stored in phosphate buffer (66 mM, pH 7.0) containing ethanol (30% v/v). No rAce-GFP could be detected using a Brad-Ford test on the washings after a 20 ml elution volume. Table 3 shows which poly-HIPEs were used for immobilization.

TABLE 3
Poly-HIPEs used to covalently immobilize rAce-GFP.

| PolyHIPE used | IBOA content | Fluorescence |
|---|---|---|
| Comparative example 2 | 10% w/w | Dependent on N-acryloxy |
| Example 1 | | succinimide loading |
| Example 2 | | |
| Example 3 | | |
| Example 4 | | |
| Comparative example 3 | 30% w/w | Dependent on N-acryloxy |
| Example 5 | | succinimide loading, but |
| Example 6 | | weaker than the previous |
| Example 7 | | series |
| Example 8 | | |
| Comparative example 4 | 40% w/w | No fluorescence |
| Example 9 | | |

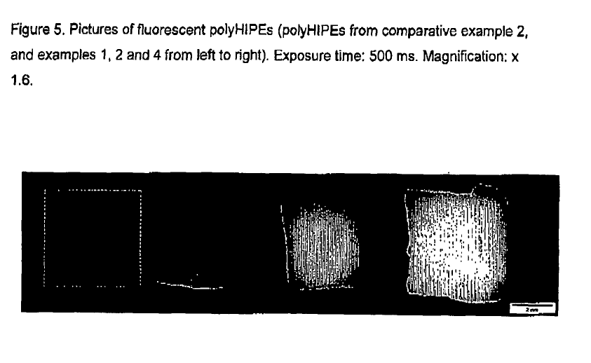

Wet poly-HIPE cubes exposed to rAce-GFP and subsequently washed were put on microscope glass slides with black backslides and examined with a Leika MZFLIII fluorescence microscope under a blue lamp (emission: 480±50 nm). Pictures were taken with a Leika CC-12 digital camera. Pictures from poly-HIPEs, which is believed to take place by reactions between basic surface residues of the proteins (probably mainly lysines) and the activated ester functionally of the N-acryloxy succinimide, of comparative example 2, and examples 1, 2, 4 can be seen in FIG. 5 and show a clear relationship between fluorescence and the amount of functional monomers (NASI) in the poly-HIPEs. Comparative example 2 contains no functional monomer and displays no fluorescence, suggesting that very little or no rAce-GFP can be physically adsorbed on this non-functional poly-HIPE.

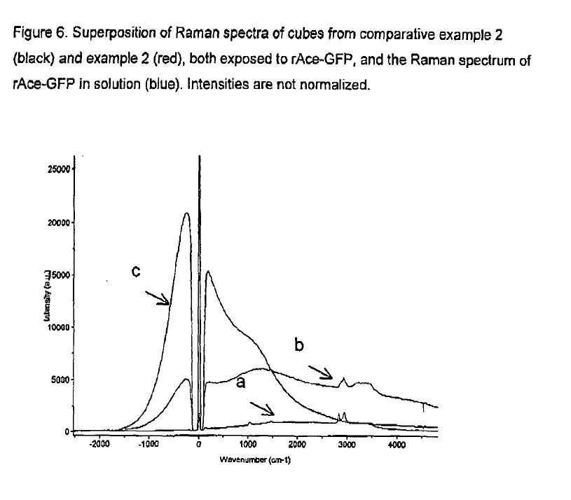

The immobilization reaction on poly-HIPEs which is believed to take place by reactions between basic surface residues of the proteins (for example lysines) and the activated ester functionality of the N-acryloxysuccinimide with equivalent loadings- of N-acryloxysuccinimide, is less efficient when the isobornyl acrylate quantity in the poly-HIPE increases, due probably to a steric hindrance effect of the bulky isobornyl group that makes the succinimide ester of NASI inaccessible to most proteins. Cubes of non-functional poly-HIPE (comparative example 2) and N-acryloxysuccinimide-containing poly-HIPE (example 2) exposed to rAce-GFP and subsequently washed were put on a Petri dish containing phosphate buffer (66 mM, pH 7.0) and ethanol (30% v/v). A Raman spectrum of each cube was taken using a Raman laser at 524-532 nm and compared to the Raman spectrum of a solution of free rAce-GFP. Fluorescence being a strong competing effect for the Raman effect, it is generally not possible to use Raman spectroscopy for fluorescent materials. Surprisingly, the Raman laser was used to determine the fluorescence inside the poly-HIPEs cubes in FIG. 6, because rAce-GFP absorption is not far from the laser wavelength. Cube from comparative example 2 showed no fluorescence (black spectrum), confirming that the acrylate-based poly-HIPEs themselves were non fluorescent and that they were not able to immobilize rAce-GFP covalently or physically. The cube from example 2 (red curve) exhibited a fluorescence peak centered nearly on the laser wavelength (around 505 nm) and corresponding to the fluorescence peak of rAce-GFP in solution (blue spectrum).

It proved that a highly porous polymer such as an acrylate-based poly-HIPE containing a functional monomer such as N-acryloxysuccinimide was able to covalently graft a protein, in this case rAce-GFP. By focusing the confocal laser on different points through the thickness of the cube from example 2, it was also shown that the fluorescence was constant and thus the immobilization was homogeneous throughout the cube volume.

### Preparation of CAL-B for Immobilization (Dialysis and Buffer Exchange)

In this section the process used to prepare Candida Antarctica Lipase B (CAL-B) for the covalent immobilization on poly-HIPEs containing succinimide esters is described. It involved mostly dialysis of the protein to change the buffer and remove additives in which CAL-B was delivered. It should be underlined that this process, described with phosphate buffer (66 mM, pH 8.0), is applicable to any aqueous buffer and any pH suitable for the used enzymes.

Novozym N525L was used as a source of pure CAL-B. N525L was delivered in an unknown buffer (pH7.0) and with glycerol (50% v/v). Two Millipore Centricon Plus-20 centrifugal units (molecular weight cut-off of the membrane: 20000) were used to exchange the buffer and remove glycerol. Each tube was loaded with N525L (8 mL) and phosphate buffer (9 mL, 66 mM, pH 8.0), and then centrifuged 8 times at 2000 G for 20 minutes, and the volume was completed to 17 mL with phosphate buffer after each run. Then the CAL-B concentrates from both tubes were collected and dispersed in phosphate buffer (66 mM, pH 8.0) to have a final volume of 10.5 mL. A Brad-Ford protein measurement was performed to determine the CAL-B concentration in the final solution.

### Example 11

Example 11 describes a general process for the immobilization of Candida Antarctica Lipase B (CAL-B) on a photo-poly-HIPE containing N-acryloxysuccinimide (from example 4). It should be underlined that this process, described with phosphate buffer (66 mM, pH 8.0), is applicable to any aqueous buffer and any pH suitable for the used enzymes. In this case, phosphate buffer (66 mM, pH 7.0) containing ethanol (20% v/v) was chosen as a buffer for storage and enzymatic activity testing, but other buffers or solvents can be used depending on which purposes the supported enzymes have.

A piece of poly-HIPE from example 4 was cut and weighed (100 mg usually). It was put in a 10 ml transparent glass sample bottle containing CAL-B (1 ml, dialyzed N525L from the previous section), phosphate buffer (3 ml, 66 mM, pH 7.0) and ethanol (1 ml). Sample bottles were shaken for 4 h at room temperature on a roller stirrer. Then the sample bottle content was poured on a 5.5 cm diameter paper filter, vacuum was applied on the filter unit and a mixture of phosphate buffer (66 mM, pH 7.0) containing ethanol (20% v/v) was added drop-wise on the polyHIPE piece. The suction effect allowed a quick washing by driving solvent through the polymer. Around 50 ml were used to wash the poly-HIPE, and it was stored in phosphate buffer (66 mM, pH 7.0) containing ethanol (20% v/v). The washing fraction was submitted to a Brad-Ford test to determine the quantity of non-immobilized CAL-B and the quantity of CAL-B immobilized in the poly-HIPE. Furthermore, it should noted that given the covalent nature of this immobilization, no immobilized CAL-B could be removed from the polymer without using conditions that degraded the immobilized enzyme or the polymer matrix.

### Example 12

Example 12 describes an activity test on Candida Antarctica Lipase B (CAL-B) from Novozym N525L based on the enzymatic hydrolysis of a para-nitrophenyl ester substrate.

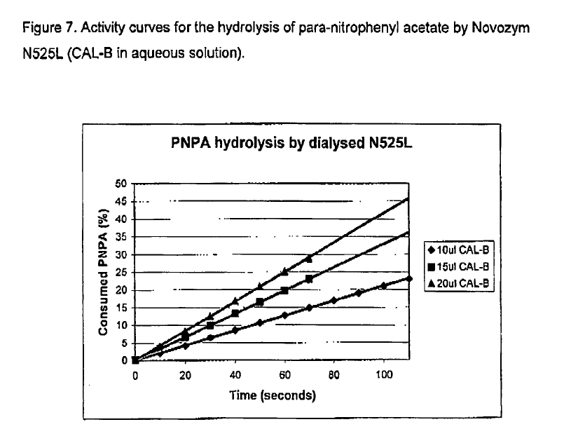

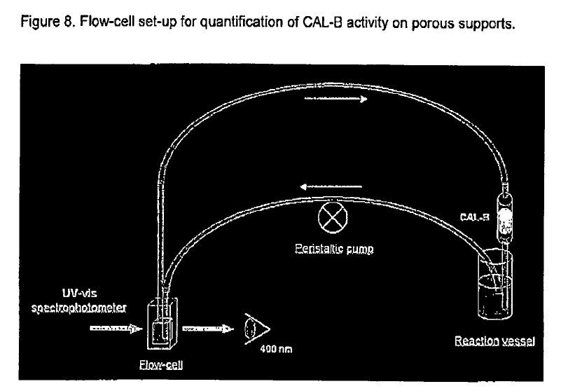

Para-nitrophenyl acetate (PNPA) was used as a substrate to assess CAL-B hydrolysis activity. Phosphate buffer (1.9 ml, 66 mM, pH 7.0) containing ethanol (20% v/v) was put in a 2 ml UV-visible quartz cell. Then PNPA (0.1 ml, 4×10⁻³ mmol, 7.25 mg/ml solution in absolute ethanol) was added and the absorbance increase at 400 nm in an Hitachi U-2000 UV-visible spectrophotometer was followed for 2 minutes, to have a measurement of the background PNPA chemical hydrolysis rate in the buffer. Then CAL-B diluted in water (various volumes from 0 to 0.10 ml) was added, and the absorbance increase at 400 nm due to para-nitrophenol release was followed until deviation from linearity was observed. For calculations, activities were deduced from the slopes of the absorbance increase curves, and the chemical hydrolysis activity was subtracted from the total activity to quantify the sole enzymatic hydrolysis activity. FIG. 7 shows activity curves with various amounts of dialyzed and diluted Novozym N525L.

### Example 13

Example 13 describes a set-up that was used to determine the activity of various porous supports (CAL-B on poly-HIPEs, CAL-B on beads) under reproducible conditions (support weight, flow-rate, time). This set-up was used to compare the activities of different supported CAL-B obtained from immobilization experiments performed as described in example 11.

A closed loop was built using a UV-visible quartz flow-cell (internal volume: ml) connected to a mini-column (20 mm length, 5 mm internal diameter) above a reservoir (a 10 ml glass sample bottle) using silicone rubber tubings (1.5 mm internal diameter). The peristaltic pump was put on the tubing right before the flow-cell to create a rapid flow (30 ml/min) in the loop. Various supported CAL-B could be packed on top of the mini-column glass filter to force the liquid flow through the supports. Phosphate buffer (9.50 ml, 66 mM, pH 7.0) containing ethanol (20% v/v) was re-circulated through the loop to define the zero absorbance at 400 nm. Then PNPA (0.50 ml, 20×10⁻³ mmol, 7.25 mg/ml solution in absolute ethanol) was added in the reaction vessel and the absorbance increase at 400 nm due to para-nitrophenol chemical hydrolysis was followed for 2 minutes from the moment it was linear. Supported CAL-B was then added in the mini-column and the absorbance increase at 400 nm was monitored as long as it was linear (typically 1 to 5 minutes).

The packed supported enzymes could be rinsed and reused to assess their stability in time and over successive uses. For calculations, activities were deduced from the slopes of absorbance increase curves, and the chemical hydrolysis activity was subtracted from the total activity to quantify the enzymatic hydrolysis activity alone.

### Example 14

Example 14 is an example of stability comparison between several supports containing the same enzyme, Candida Antarctica Lipase-B (CAL-B, from Novozym N525L).

As a reference, Novozym N435 was used. It consists of CAL-B physically adsorbed on beads of a polyacrylic resin. The loading of CAL-B determined by CHN analysis was around 8% w/w (80 mg CAL-B/g of beads) and N435 surface area was 105 m²/g.

As a second reference, a styrenic thermal poly-HIPE similar to the one made in comparative example 1 was chosen, as these styrenic poly-HIPEs are know to be able to physically adsorb enzymes via hydrophobic interactions (non covalent immobilization). CAL-B was physically adsorbed on this poly-HIPE as described in example 11 for covalent immobilization. The loading of CAL-B determined by protein measurement on the washing solution after immobilization of the enzyme was around 0.75% w/w (7.5 mg CAL-B/g of poly-HIPE). This support was used as a powder.

As negative controls, the poly-HIPE from example 4 without grafted CAL-B was used to verify that this polymer alone did not have any effect on the hydrolysis. The other negative control was the poly-HIPE from example 1 on which it was attempted to adsorb physically CAL-B using a process similar to example 11, but with MES buffer (100 mM, pH 6.0) as the solvent for the immobilization. No adsorbed CAL-B could be detected. These poly-HIPEs were used as monoliths of 5 mg.

Finally, the poly-HIPE from example 4 was chosen to covalently immobilize CAL-B using a process similar to example 11 but with MES buffer (100 mM, pH 6.0) as the solvent for the immobilization. The loading of CAL-B determined by protein measurements on the washing solution after immobilization of the enzyme was around 0.80% w/w (8.0 mg CAL-B/g of poly-HIPE). These poly-HIPEs were used as monoliths of 5 mg.

Each of these supports was tested as stated in example 13 and in various amounts.

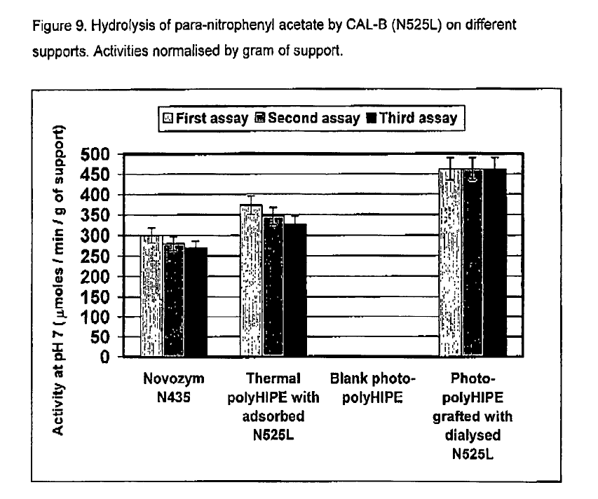

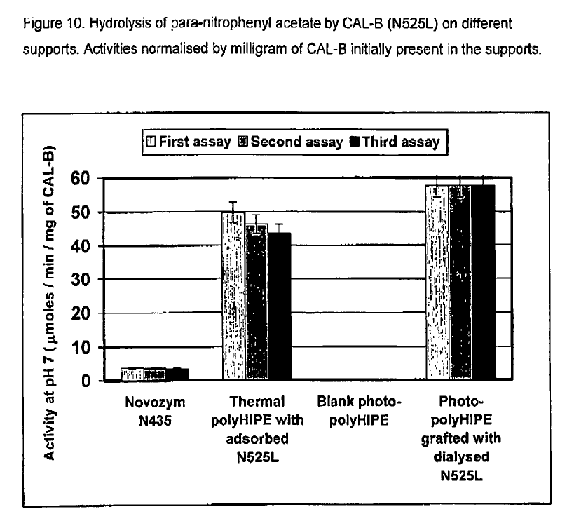

The results are summarized in FIGS. 9 and 10. These figures show the enzymatic activity for the hydrolysis of para-nitrophenyl acetate into para-nitrophenol and acetic acid for each support, normalized by gram of support in FIG. 9 and by milligram of immobilized CAL-B in FIG. 10.

There were three clear conclusions from these results:

a) The commercial CAL-B Novozym N435 had an overall activity per gram of support comparable to the activities obtained with both thermal styrenic containing adsorbed CAL-B and photo-poly-HIPEs containing CAL-B covalently immobilized. These thermal styrenic and photo-poly-HIPEs exhibited activities per milligram of CAL-B comparable to CAL-B in solution (around 50 μmoles/min/mg CAL-B for Novozym N525L), whereas Novozym N435 was more than 10 times less active. It means that either most of the adsorbed CAL-B in N435 is not accessible to the substrate, or it is not as active as CAL-B in solution. This shows that the process according to the invention is efficient in terms of utilizing a lower amount of enzyme and

b) There was no physical adsorption of CAL-B on non-functional photo-poly-HIPEs, due to the aliphatic acrylate-based formulation. Furthermore, these poly-HIPEs had no effect on ester hydrolysis.

c) The stability of covalently grafted CAL-B over time and over subsequent reuse was very good compared to supports where it was only physically adsorbed. No decrease of activity (in the limits of experimental reproducibility) could be detected by using 10 times the same support for hydrolysis of para-nitrophenyl acetate. No decrease of activity could be detected after 3 months of storage in phosphate buffer (66 mM, pH 7.0) containing ethanol (20% v/v) of the supported CAL-B on example 4 poly-HIPE.

### Examples 15-18

These examples are based on a fixed mole ratio of EHA:IBOA:TMPTA: NASI (11.65:65.82:8.19:14.34) with varying surfactant types and additives. The addition of CaCl₂ (example 15) was found, as would be anticipated to those skilled in the art, to have a stabilizing effect on the HIPE. The mixed surfactant system reported elsewhere [WO 97/45479] and used in example 18, produces a HIPE with a viscous gel-like consistency and good thermal stability.

The use of Hypermer B246 was, unexpectedly, found to enhance the retention of NASI in the poly-HIPE resulting in 84% loading efficiency in both examples 16 and 17. This compares very favorably with example 4 (62%) in which NASI was also added to the droplet phase, and to all other examples where a range of 30% to 59% loading efficiency was observed.

Examples 15 to 18 were made in the same way as examples 1-9. Example 18 was polymerized thermally at 60° C. under a nitrogen atmosphere for 16 hrs.

| | % weight/oil phase (total weight) | | | | | | | | | | | |
|---|---|---|---|---|---|---|---|---|---|---|---|---|
| | | | | | | | | | | | CaCl₂ | Water:oil |
| | | | | Darocure | | | Hypermer | | | | (in aq | phase ratio |
| Poly-HIPE | EHA | IBOA | TMPTA | 4265 | NASI | SPAN80 | B246 | AIBN | CTA CI | SDS | phase) | (water weight) |
| Example 15 | 50.0 | 10.0 | 10.0 | 7.0 | 10.0 | 13.0 | | | | | | 9:1 |
| | (2.50 g) | (0.50 g) | (0.50 g) | (0.35 g) | (0.50 g) | (0.65 g) | | | | | (5.50 g) | (45.0 g) |
| Example 16 | 55.9 | 11.2 | 11.2 | 7.8 | 11.2 | | 2.8 | | | | | 9:1 |
| | (2.79 g) | (0.56 g) | (0.56 g) | (0.39 g) | (0.56 g) | | (0.14 g) | | | | | (45.0 g) |
| Example 17 | 54.3 | 10.9 | 10.9 | 7.6 | 10.9 | | 5.4 | | | | | 9:1 |
| | (2.50 g) | (0.50 g) | (0.50 g) | (0.35 g) | (0.50 g) | | (0.25 g) | | | | | (45.0 g) |
| Example 18 | 52.3 | 10.5 | 10.5 | | 10.5 | 13.2 | | 1.0 | 1.0 | 1.0 | | 9:1 |
| | (2.50 g) | (0.50 g) | (0.50 g) | | (0.50 g) | (0.63 g) | | (0.05 g) | (0.05 g) | (0.05 g) | (4.50 g) | (45.0 g) |

CTA Cl, cetyltrimethylamonium chloride (25% aq, Aldrich); Hypermer B246, 12-hydroxystearic acid-polyethylene glycol block copolymer (Uniqema); AIBN, azobisisobutyronitrile (Fluka); SDS, sodium dodecylsulphonate (Aldrich).

### Example 19

### Coupling of DERA

Escherichia coli D-2-deoxyribose-5-phosphate aldolase (DERA) cell free extract (over expressed in Escherichia coli), (50 ml) was immobilised by passing continuously through a piece of N-acryloxysuccinamide-co-polymer poly-HIPE (1 g) for a period of 6 Hrs at 22° C. and pH 6.60. The polymer was subsequently washed with triethanolamine buffer (200 ml, 50 mM, pH 7.25) to leave an off white polymer monolith containing the immobilized enzyme, DERA.

| | | | |
|---|---|---|---|
| i. | total protein concentration in solution prior | 23.6 | mg/ml |
| | to immobilization: | | |
| ii. | total protein concentration 6 hrs after flowing | 21.3 | mg/ml |
| | through the n-hydroxysuccinamide functional | | |
| | polymer: | | |
| iii. | Protein concentration was determined by the | | |
| | Bradford assay as described previously | | |
| iv. | Resultant loading of DERA on poly-HIPE: | 115 | mg/g |

### Example 20

Coupling of s-HNL

Hevea brasiliensis s-Hydroxynitrile lyase (s-HNL) cell free extract (over expressed in Pichia pastoris) (50 ml) was immobilized by passing continuously through a piece of N-acryloxysuccinamide-co-polymer poly-HIPE (1 g) for a period of 6 Hrs at 22° C. and pH 5.75 The polymer was subsequently washed with MES buffer (100 ml, 50 mM, pH 5.80) to leave an off white polymer monolith containing the immobilized enzyme, s-HNL.

| | | | |
|---|---|---|---|
| i. | Total protein concentration in solution prior | 49.9 | mg/ml |
| | to immobilization: | | |
| ii. | 6 hrs after flowing through the | 27.0 | mg/ml |
| | n-hydroxysuccinamide functional polymer: | | |
| iii. | Protein concentration was determined by the | | |
| | Bradford assay as described previously. | | |
| iv. | Resultant loading of s-HNL on poly-HIPE: | 150 | mg/g |

### Example 21

### DERA-Copolymerization

Escherichia coli D-2-deoxyribose-5-phosphate aldolase (DERA) cell free extract (over expressed in Escherichia coli), (45 ml of 1 mg/ml protein content) was immobilized by co-polymerization into the poly-HIPE.

The poly-HIPE was formed as in examples 1-12 but by addition of DERA cell free extract to the organic phase instead of water or aqueous solutions of CaCl₂ and/or NASI. The resulting piece of poly-HIPE was then washed with potassium phosphate buffer (5×100 ml, 50 mM, pH 7.00) to leave an off white polymer monolith containing the immobilized enzyme, DERA.

1. A process for preparing highly porous polymeric materials capable of covalently grafting biologically active species comprising the steps of:
a. Preparing an emulsion comprising a droplet phase and a continuous phase from a composition comprising:
A) 5-95 wt % of a functional monomer
B) 5-80 wt % of a cross-linking monomer
C) 0-10 wt % of a polymerization initiator
D) 0-20 wt % of a surfactant
E) 0-90 wt % of a monomer other than a functional or cross-linking monomer wherein the weight percentage are relative to the total weight of A, B, C, D and E, and F, between 74-93 vol % of a liquid or liquid composition that constitutes the droplet phase, whereby the vol % is relative to the total volume of the continuous phase comprising A, B, C, D and E and the droplet phase.
b. Curing the emulsion, and
c. Optionally removing the water/droplet phase,
and wherein the functional monomer contains an active ester group, a maleimide, a thiol, an isothiocyanate, a iodoacetamide, a 2-pyridyl derivative, an azide, an oxime, an epoxide, an isocyanate or an aldehyde functionality.

2. A process according to claim 1, where the monomers, crosslinking monomers and functional monomers contain vinylic unsaturation.

3. A process according to claim 1, where the functional monomers have the general structural formula P-G or P-X-G, wherein P is the chemical moiety involved in polymerization and G is the chemical moiety which is subsequently used to graft biologically active species, and wherein X is any spacer group, which spacer group may be hydrophilic or hydrophobic.

4. A process according to claim 1, wherein the functional group is an activated ester group of formula (2) 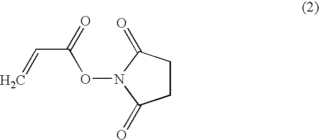
or formula (3) 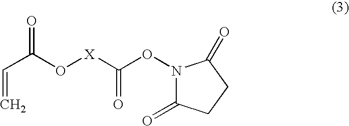
wherein X is a spacer group, which spacer group may be hydrophilic or hydrophobic.

5. Highly porous polymeric material obtainable by a process according to claim 1.

6. A process for grafting biologically active species to a highly porous polymeric material according to claim 5 comprising the steps of:
a. Exposing the highly porous material to a solution of the biologically active species in a suitable solvent medium
b. Optionally adding an activating agent
c. Optionally heating
d. Rinsing the porous material with solvent medium to remove non-grafted species.

7. A process according to claim 6, where the solvent medium used in the solution of the biologically active species is water and more preferably an aqueous buffer.

8. A process according to claim 7, where the solvent medium used in the solution of the biologically active species is an organic solvent.

9. A process according to claim 7, where the solvent medium used in the solution of the biologically active species is a mixture of water and an organic solvent or more preferably a mixture of an aqueous buffer and organic solvent.

10. Highly porous polymeric material comprising covalently grafted biologically active species obtained by a process according to claim 7.

11. A heterogeneous catalysts comprising a highly porous polymeric material comprising biologically active species according to claim 10.

12. A highly porous material comprising biologically active species according to claim 10 wherein the catalytic activity remains greater than 90% of the original activity under the same reaction conditions after 10 reaction and rinsing cycles.

13. A device which comprises a highly porous polymeric material comprising biologically active species according to claim 10, wherein the device is selected from biosensors, chromatography, biomedical devices and implants.

14. Biologically and bio-chemically active devices comprising a highly porous polymeric material comprising biologically active species according to claim 10.
